(19) United States
(12) Patent Application Publication
(10) Pub. No.: US 2022/0267191 A1
(43) Pub. Date: Aug. 25, 2022

(54) LOADING APPARATUS FOR GLASS PLATE AND METHOD OF STRENGTHENING GLASS PLATE USING THE SAME

(71) Applicant: Samsung Display Co., Ltd., Yongin-Si (KR)

(72) Inventors: HYUNJI LEE, Gimhae-si (KR); YONGKYU KANG, Hwaseong-si (KR); HOIKWAN LEE, Suwon-si (KR)

(21) Appl. No.: 17/516,866

(22) Filed: Nov. 2, 2021

(30) Foreign Application Priority Data
Feb. 24, 2021 (KR) 10-2021-0024998

(51) Int. Cl. C03B 35/20; C03B 27/012; C03B 27/03

(52) U.S. Cl. CPC C03B 35/207; C03B 27/012; C03B 35/205; C03B 27/03

(57) ABSTRACT

A loading apparatus for glass plates includes first and second frames facing each other and supporters extending in a first direction, disposed between the first frame and the second frame, and coupled with the first frame and the second frame. Each of the plurality of supporters includes a supporting bar and a coating layer covering at least a portion of the supporting bar. The plurality of supporters supports the glass plates arranged in the first direction, and the coating layer includes at least one of Teflon, molybdenum, ceramic, and metal oxide.

This application claims priority to Korean Patent Application No. 10-2021-0024998, filed on Feb. 24, 2021, and all the benefits accruing therefrom under 35 U.S.C. § 119, the content of which in its entirety is herein incorporated by reference.

### BACKGROUND

### 1. Field

Embodiments of the invention relate to a loading apparatus for glass plates. More particularly, embodiments of the invention relate to a loading apparatus for glass plates to perform a process of strengthening the glass plates.

### 2. Description of the Related Art

A display device providing images to a user is applied to various multimedia devices, such as a television, a mobile phone, a tablet computer, and a game unit. The display device includes various modules to display the images and includes a cover glass to protect the modules of the display device. In recent years, the display device is designed with a thin thickness for slimness of the display device, thereby increasing a user's convenience. The cover glass is also manufactured to have a thin thickness.

When a strengthening process is performed on the cover glass, the cover glass is prevented from being easily damaged by external impacts. As one of the strengthening processes for the cover glass, a chemical strengthening method is used.

### SUMMARY

For a strengthening process of a cover glass, a loading apparatus that loads a large number of cover glasses without damaging the cover glass is desired. However, the cover glass having a thin thickness is easily damaged during the strengthening process.

Embodiments of the invention provide a loading apparatus for glass plates, which is capable of preventing the glass plates from being damaged and deformed while loading the glass plates for the strengthening process for the glass plates.

Embodiments of the invention provide a method of strengthening the glass plate using the loading apparatus.

An embodiment of the invention provides a loading apparatus for glass plates including a first frame, a second frame facing the first frame, and a plurality of supporters extending in a first direction, disposed between the first frame and the second frame, and coupled with the first frame and the second frame. Each of the plurality of supporters includes a supporting bar and a coating layer covering at least a portion of the supporting bar. The plurality of supporters supports the glass plates arranged in the first direction, and the coating layer includes at least one of Teflon, molybdenum, ceramic, and metal oxide.

In an embodiment, the ceramic includes at least one of alumina, silica, magnesia, zirconia, and mullite.

In an embodiment, the metal oxide includes at least one of aluminum oxide, molybdenum oxide, manganese oxide, and magnesium oxide.

In an embodiment, the glass plates are in contact with the coating layer.

In an embodiment, the supporting bar is provided with a plurality of grooves defined therein along the first direction, and the plurality of grooves supports the glass plates.

In an embodiment, each of the plurality of grooves includes side surfaces and a surface disposed between the side surfaces, the side surfaces face a first surface or a second surface of a corresponding glass plate among the glass plates, which is supported by a corresponding groove among the plurality of grooves where the first surface of the corresponding glass faces the first frame and the second surface of the corresponding glass is opposite to the first surface and faces the second frame, and the surface of each of the plurality of grooves faces a side surface of the corresponding glass plate among the glass plates, which is supported by the corresponding groove among the plurality of grooves.

In an embodiment, each of the plurality of grooves is defined in a first surface of the supporting bar facing the glass plates, and the plurality of grooves is spaced apart from each other with the first surface of the supporting bar interposed therebetween.

In an embodiment, the coating layer covers an entire area of the supporting bar.

In an embodiment, the coating layer covers some areas of the supporting bar overlapping the plurality of grooves.

In an embodiment, the coating layer overlapping the plurality of grooves has a uniform thickness.

In an embodiment, each of the glass plates includes side surfaces, and the plurality of supporters includes two or more supporters supporting different side surfaces among the side surfaces of each of the glass plates.

In an embodiment, the first direction is substantially parallel to a normal line direction of a main extension plane of each of the glass plates.

In an embodiment, the loading apparatus further includes a sub-supporting bar coupled with the first frame and the second frame, and the sub-supporting bar is disposed on a side surface that is not supported by the plurality of supporters among the side surfaces of each of the glass plates.

In an embodiment, each of the glass plates has a thickness equal to or greater than about 20 micrometers (μm) and equal to or less than about 50 μm in the first direction.

In an embodiment, each of the glass plates has a Young's modulus equal to or greater than about 65 gigapascals (Gpa) and equal to or less than about 75 GPa.

An embodiment of the invention provides a method of strengthening glass plates. The method includes loading the glass plates into a loading apparatus, pre-heating the loading apparatus into which the glass plates are loaded at a first temperature, immersing the loading apparatus into which the glass plates are loaded in a molten salt heated to the first temperature to strengthen the glass plates, post-heating the loading apparatus into which the glass plates are loaded at a second temperature, after taking out the loading apparatus into which the glass plates are loaded from the molten salt, and placing the glass plates under a room temperature to cool down the glass plates. The loading apparatus includes a supporter to support the glass plates, and the supporter is coated with a coating layer including a hydrophobic material.

In an embodiment, the molten salt includes a potassium ion.

In an embodiment, the first temperature is equal to or greater than about 350 degrees Celsius (° C.) and equal to or less than about 400 degrees Celsius (° C.).

In an embodiment, the second temperature is equal to or greater than about 220 degrees Celsius (° C.) and equal to or less than about 320 degrees Celsius (° C.).

In an embodiment, the coating layer includes at least one of Teflon, molybdenum, ceramic, and metal oxide.

According to the above, the loading apparatus for the glass plates prevents the glass plates from being damaged and deformed during the strengthening process for the glass plate while loading the glass plates.

In addition, the method of strengthening the glass plates using the loading apparatus for the glass plates strengthens the glass plate while preventing the glass plate from being damaged and deformed.

### BRIEF DESCRIPTION OF THE DRAWINGS

The above and other advantages of the invention will become readily apparent by reference to the following detailed description when considered in conjunction with the accompanying drawings, in which:

FIGS. 1A and 1B are perspective views showing an embodiment of loading apparatuses for a glass plate according to the invention;

FIG. 2 is a perspective view showing an embodiment of a loading apparatus for a glass plate according to the invention;

FIG. 3 is a cross-sectional view showing an embodiment of a loading apparatus for a glass plate according to the invention;

FIG. 4 is a cross-sectional view showing an embodiment of a loading apparatus for a glass plate according to the invention;

FIGS. 5A and 5B are cross-sectional views showing an embodiment of loading apparatuses for a glass plate according to the invention;

FIG. 6A is a cross-sectional view showing a glass plate on which a strengthening process is performed after being loaded into a comparative example of a loading apparatus;

FIG. 6B is a cross-sectional view showing a glass plate on which a strengthening process is performed after being loaded into an embodiment of a loading apparatus according to the invention;

FIGS. 7A to 7C are cross-sectional views showing an embodiment of supporters according to the invention;

FIG. 8 is a flowchart showing an embodiment of a method of strengthening a glass plate according to the invention;

FIGS. 9A to 9E are cross-sectional views showing an embodiment of processes of strengthening the glass plate according to the invention;

FIG. 10 is a graph showing a Young's modulus of a glass plate as a function of a temperature;

FIGS. 11A and 11B are schematic views showing an embodiment of processes of strengthening the glass plate according to the invention; and

FIG. 12 is a graph showing a viscosity of a molten salt as a function of a temperature.

### DETAILED DESCRIPTION

The disclosure may be variously modified and realized in many different forms, and thus specific embodiments will be exemplified in the drawings and described in detail hereinbelow. However, the invention should not be limited to the specific disclosed forms, and be construed to include all modifications, equivalents, or replacements included in the spirit and scope of the invention.

In the disclosure, it will be understood that when an element or layer is referred to as being “on”, “connected to” or “coupled to” another element or layer, it can be directly on, connected or coupled to the other element or layer or intervening elements or layers may be present.

Like numerals refer to like elements throughout. In the drawings, the thickness, ratio, and dimension of components are exaggerated for effective description of the technical content.

As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another element. Thus, a first element discussed below could be termed a second element without departing from the teachings of the disclosure. As used herein, the singular forms, “a”, “an” and “the” are intended to include the plural forms as well, unless the context clearly indicates otherwise.

Spatially relative terms, such as “beneath”, “below”, “lower”, “above”, “upper” and the like, may be used herein for ease of description to describe one element or feature's relationship to another element(s) or feature(s) as shown in the drawing figures.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term “about” can mean within one or more standard deviations, or within ±30%, 20%, 10%, 5% of the stated value, for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Hereinafter, a loading apparatus for a glass plate and a method of strengthening the glass plate using the loading apparatus according to the disclosure will be explained in detail with reference to the accompanying drawings.

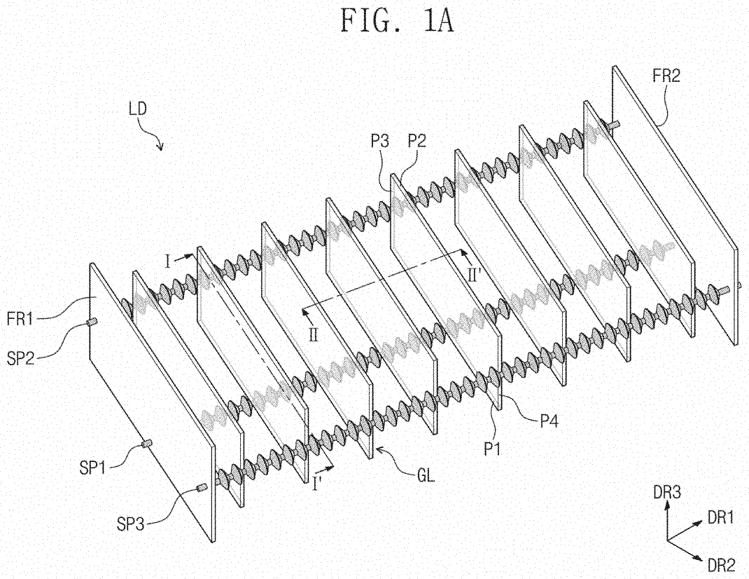

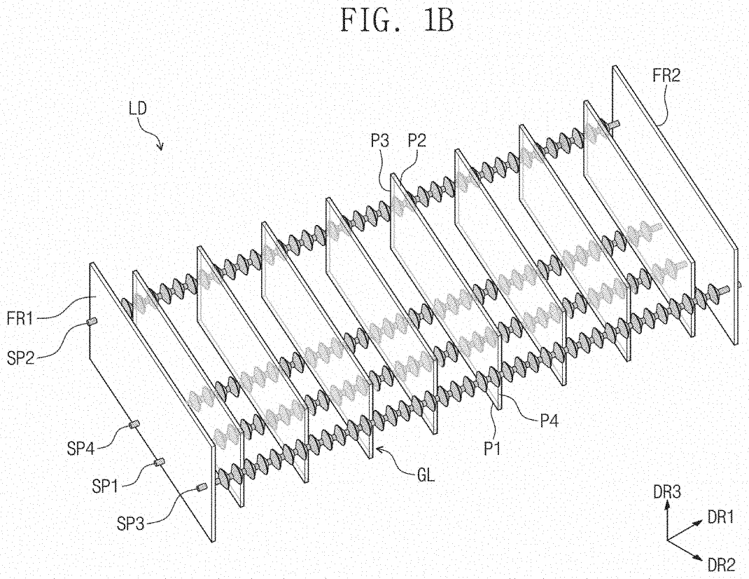

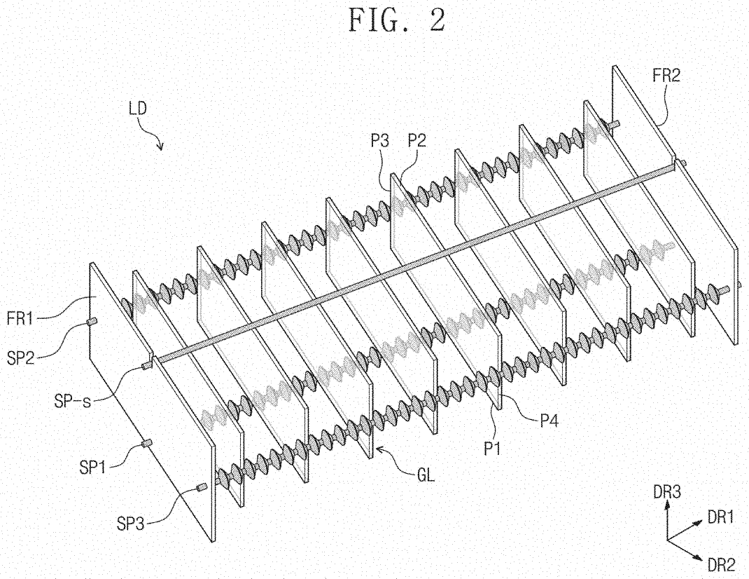

FIGS. 1A, 1B, and 2 are perspective views showing an embodiment of the loading apparatuses for the glass plate according to the invention. The loading apparatuses LD for the glass plate shown in FIGS. 1A, 1B, and 2 include substantially the same configurations as each other expect some components. Hereinafter, the loading apparatus for the glass plate will be referred to as a loading apparatus.

The loading apparatus LD may substantially simultaneously load a plurality of glass plates GL for a strengthening process of the glass plates GL. Referring to FIGS. 1A, 1B, and 2, the glass plates GL may be loaded into the loading apparatus LD.

The loading apparatus LD may include a plurality of frames FR1 and FR2 and a plurality of supporters SP1, SP2, and SP3. The strengthening process of the glass plate described later may include a strengthening operation of immersing the glass plates GL into a molten salt. The glass plates GL may be substantially simultaneously immersed into the molten salt while being loaded into the loading apparatus LD.

Each of glass plates GL may include an upper surface (or a front surface), a lower surface (or a rear surface) opposite to the upper surface, and side surfaces P1, P2, P3, and P4 connecting the upper surface and the lower surface. A distance between the upper surface and the lower surface of the glass plate GL may correspond to a thickness of the glass plate GL. FIGS. 1A, 1B, and 2 show the glass plates GL that are arranged to allow each of the upper surface and the lower surface of the glass plates GL to be substantially parallel to a surface defined by a second direction DR2 and a third direction DR3.

Referring to FIG. 1A, the glass plate GL may include first and second side surfaces P1 and P2 extending in the second direction DR2 and third and fourth side surfaces P3 and P4 extending in the third direction DR3. The first side surface P1 and the second side surface P2 may be opposite to each other in the third direction DR3, and the third side surface P3 and the fourth side surface P4 may be opposite to each other in the second direction DR2.

An upper portion and a lower portion of the loading apparatus LD may be exposed to the outside. The loading apparatus LD may load the glass plates GL while exposing the upper surface and the lower surface of the glass plates GL. In the strengthening process of the glass plates GL, the molten salt may enter the loading apparatus LD through the exposed portions of the loading apparatus LD and may be in contact with the upper surface and the lower surface of the glass plates GL.

The glass plate GL may be used as a cover glass of a display device. The glass plate GL loaded into the loading apparatus LD may be, but not limited to, an ultra-thin-glass (“UTG”) with a thin thickness. In an embodiment, the glass plate GL may have a thickness THg (refer to FIG. 4) equal to or less than about 100 micrometers (μm), specifically equal to or greater than about 20 μm and equal to or less than about 50 μm, in the first direction DR1.

The frames FR1 and FR2 may include a first frame FR1 and a second frame FR2. The first frame FR1 and the second frame FR2 may be spaced apart from each other and may face each other in the first direction DR1. The first frame FR1 and the second frame FR2 may support a plurality of supporters SP1, SP2, and SP3 coupled with the first and second frames FR1 and FR2. Each of the first frame FR1 and the second frame FR2 may be provided with a coupling groove with which the supporters SP1, SP2, and SP3 are coupled.

The first and second frames FR1 and FR2 may include a material having a heat resistance so as not to be deformed at a high temperature. In an embodiment, the first and second frames FR1 and FR2 may include a metal material or a carbon composite that is not deformed at a temperature of about 400 degrees Celsius (° C.), however, the material for the first and second frames FR1 and FR2 should not be particularly limited.

Each of the supporters SP1, SP2, and SP3 may be coupled to each of the first and second frames FR1 and FR2 and may be disposed between the first and second frames FR1 and FR2. In an embodiment, each of one ends of the supporters SP1, SP2, and SP3 may be coupled with the coupling groove of the first frame FR1. Each of the other ends of the supporters SP1, SP2, and SP3 may be coupled with the coupling groove of the second frame FR2. The supporters SP1, SP2, and SP3 may be fixed with the first and second frames FR1 and FR2.

Each of the supporters SP1, SP2, and SP3 may support the glass plates GL. As the glass plates GL are supported by the supporters SP1, SP2, and SP3, the strengthening process may be performed on the glass plates GL while the glass plates GL are loaded into the loading apparatus LD.

The supporters SP1, SP2, and SP3 may include two or more supporters that support different side surfaces among the side surfaces P1, P2, P3, and P4 of the glass plate GL. FIG. 1A shows first, second, and third supporters SP1, SP2, and SP3 each of which supports different side surfaces of the glass plates GL as a representative example. However, the number of the supporters may be smaller or greater than that shown in drawing figures and should not be particularly limited.

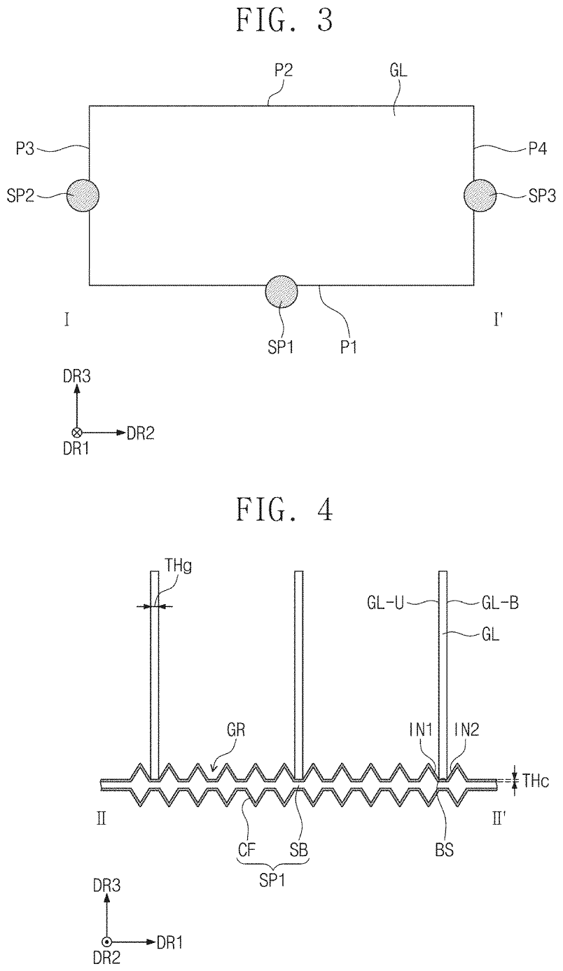

FIG. 3 is a cross-sectional view taken along line I-I′ shown in FIG. 1A to show the loading apparatus. Referring to FIGS. 1A and 3, the first supporter SP1 may support first side surfaces P1 of the glass plates GL, which face a downward direction of the loading apparatus LD. When the loading apparatus LD is lifted upward, the first supporter SP1 may support the glass plates GL.

The second supporter SP2 may support third side surfaces P3 of the glass plates GL. The third supporter SP3 may support fourth side surfaces P4 of the glass plates GL. The second supporter SP2 and the third supporter SP3 may prevent the glass plates GL from shaking in lateral directions, e.g., second direction DR2.

FIGS. 1A and 3 show the supporters SP1, SP2, and SP3 that respectively support different side surfaces of the glass plates GL, however, they should not be limited thereto or thereby. As shown in FIG. 1B, some supporters among the supporters may support the same side surfaces of the glass plates GL.

Referring to FIG. 1B, the loading apparatus LD may further include a fourth supporter SP4. The first, second, and third supporters SP1, SP2, and SP3 may support different side surfaces of the glass plate GL, and the fourth supporter SP4 may support the first side surfaces P1 of the glass plates GL with the first supporter SP1. However, arrangements of the supporters should not be limited to embodiments shown in FIGS. 1A and 1B.

Referring to FIG. 1A, the supporters SP1, SP2, and SP3 may extend in the same direction. The glass plates GL may be arranged in the direction in which the supporters SP1, SP2, and SP3 extend. FIG. 1A is a perspective view showing the supporters SP1, SP2, and SP3 extending in the first direction DR1 and the glass plates GL arranged in the first direction DR1 in which the supporters SP1, SP2, and SP3 extend.

Each of the glass plates GL may be loaded such that a normal line direction of a main extension plane (e.g., a plane defined by the second and third directions DR2 and DR3) of the glass plate GL is substantially parallel to the direction in which the supporters SP1, SP2, and SP3 extend. As the glass plates GL are loaded such that the upper surfaces and the lower surfaces of the glass plates GL are disposed to be substantially parallel to a direction in which a force of gravity acts (in other words, the normal line direction of the upper surfaces of the glass plates GL is substantially perpendicular to the direction in which the force of gravity acts), the glass plates GL may be prevented from sagging due to gravity. In particular, the glass plates GL may be exposed to a high temperature environment during the strengthening process of the glass plate GL, and the glass plates GL exposed to the high temperature environment may be easily sagged when compared with glass plates in a room temperature environment. However, the loading apparatus LD according to the invention may prevent the glass plates GL from sagging.

The shape and size of the supporters SP1, SP2, and SP3 should not be limited to those shown in FIG. 1A. FIG. 1A shows the supporters SP1, SP2, and SP3 having the same shape and size as each other as a representative example. However, in an embodiment, the loading apparatus LD may include supporters having different shapes from each other and different sizes from each other.

The supporters SP1, SP2, and SP3 may include the material having the heat resistance so as not to be deformed at the high temperature. In an embodiment, the supporters SP1, SP2, and SP3 may include the material that is not deformed at the temperature of about 400 degrees Celsius (° C.).

The supporters SP1, SP2, and SP3 may include a material having an erosion resistance such that the supporters SP1, SP2, and SP3 are not damaged by the molten salt used in the strengthening process of the glass plate GL.

Each of the supporters SP1, SP2, and SP3 may include a supporting bar and a coating layer. This will be described in detail later.

Referring to FIG. 2, the loading apparatus LD may further include a sub-supporter SP-s. The sub-supporter SP-s may be coupled with each of the first frame FR1 and the second frame FR2 and may be disposed between the first frame FR1 and the second frame FR2. In an embodiment, one end of the sub-supporter SP-s may be coupled with the coupling groove of the first frame FR1. The other end of the sub-supporter SP-s may be coupled with the coupling groove of the second frame FR2. The sub-supporter SP-s may be coupled with the frames FR1 and FR2 and supported by the frames FR1 and FR2.

The sub-supporter SP-s may extend in one direction substantially parallel to the supporters SP1, SP2, and SP3. The sub-supporter SP-s may have a bar shape extending in the one direction.

The sub-supporter SP-s may be disposed on the side surface of the glass plate GL. The sub-supporter SP-s may be disposed on the side surface of the glass plate GL, which is not supported by the supporters SP1, SP2, and SP3. FIG. 2 shows the sub-supporter SP-s disposed on the second side surfaces P2 of the glass plates GL, which are not supported by the supporters SP1, SP2, and SP3, however, the sub-supporter SP-s should not be limited thereto or thereby. In an embodiment, the sub-supporter SP-s may be provided in plural, and some sub-supporters may be disposed on the side surface that is supported by the supporters SP1, SP2, and SP3 to assist the supporters SP1, SP2, and SP3.

The sub-supporter SP-s may be coupled with the frames FR1 and FR2 after the glass plates GL are loaded between the supporters SP1, SP2, and SP3. In an embodiment, the glass plates GL may be loaded between the first, second, and third supporters SP1, SP2, and SP3, and the sub-supporter SP-s may be disposed on one side surfaces of the glass plates GL, so that opposite both ends of the sub-supporter SP-s may be coupled with the coupling grooves of the first and second frames FR1 and FR2, respectively. Thus, the sub-supporter SP-s may be disposed on the second side surfaces P2 of the glass plates GL which face an upward direction of the loading apparatus LD.

The sub-supporter SP-s may support the glass plates GL. In the strengthening process of the glass plate GL, the glass plates GL may receive a force such as buoyancy by the molten salt entering through a space between the glass plates GL loaded into the loading apparatus LD, and thus, the glass plates GL may be detached from the loading apparatus LD. The sub-supporter SP-s may assist the supporters SP1, SP2, and SP3 to prevent the glass plates GL from being detached from the loading apparatus LD due to the molten salt. Referring to FIG. 2, the sub-supporter SP-s may support the second side surfaces P2 of the glass plates GL, which face the upward direction of the loading apparatus LD, and may prevent the glass plates GL from being detached from the loading apparatus LD to the upward direction.

The sub-supporter SP-s may include a material having a heat resistance so as not to be deformed at a high temperature. In an embodiment, the sub-supporter SP-s may include a metal material or a carbon composite that is not deformed at a temperature of about 400 degrees Celsius (° C.), however, the material for the sub-supporter SP-s should not be particularly limited.

Although not shown in drawing figures, the loading apparatus LD may include a plurality of sub-supporters. Each of the sub-supporters may be disposed on the side surfaces of the glass plates GL and may assist the supporters SP1, SP2, and SP3. The sub-supporters may be arranged in one direction on the same side surfaces of the glass plates GL, however, they should not be limited thereto or thereby. In an embodiment, the sub-supporters may include two or more sub-supporters disposed on different side surfaces of the glass plates GL.

FIG. 4 is a cross-sectional view taken along line II-II′ shown in FIG. 1A to show the loading apparatus. FIG. 4 shows a cross-section of a portion of the first supporter SP1 among the supporters SP1, SP2, and SP3 and the glass plates GL supported by the first supporter SP1. Hereinafter, descriptions on the first supporter SP1 may also be applied to the second supporter SP2 and the third supporter SP3, and the first supporter SP1 will be also referred to as a supporter SP1.

Referring to FIG. 4, the supporter SP1 may include a supporting bar SB and a coating layer CF.

The supporting bar SB may extend in one direction. The supporting bar SB may be provided with a plurality of grooves GR defined therein and arranged in the extension direction thereof. FIG. 4 shows a representative embodiment of the supporting bar SB in which the grooves GR are regularly formed or provided along the first direction DR1.

The supporting bar SB may include a material having a heat resistance so as not to be deformed at a high temperature. In an embodiment, the supporting bar SB may include a metal material, such as a stainless steel, that is not deformed at a temperature of about 400 degrees Celsius (° C.), however, the material for the supporting bar SB should not be particularly limited.

The grooves GR may support the glass plates GL. The glass plates GL may be loaded to correspond to some grooves GR among the grooves GR to adjust a distance between the glass plates GL, however, they should not be limited thereto or thereby. The glass plates GL may be loaded to respectively correspond to the grooves GR.

The groove GR may include inner side surfaces IN1 and IN2 and a bottom surface BS unitary with the inner side surfaces IN1 and IN2. The inner side surfaces IN1 and IN2 may be inclined with respect to the bottom surface BS. The bottom surface BS may face the side surface of the glass plate GL loaded in the groove GR. Each of the inner side surfaces IN1 and IN2 may face an upper surface GL-U or a lower surface GL-B of the glass plate GL loaded in the groove GR.

The coating layer CF may cover a surface of the supporting bar SB. The coating layer CF may be in contact with the supporting bar SB. The coating layer CF may be coated on the supporting bar SB such that a shape of the surface of the coating layer CF corresponds to a shape of the surface of the supporting bar SB. The coating layer CF may have a substantially uniform thickness THc, and may be coated on the surface of the supporting bar SB. The thickness THc of the coating layer CF may correspond to a distance between one surface of the coating layer CF facing the surface of the supporting bar SB and the other surface of the coating layer CF opposite to the one surface. In an embodiment, the thickness THc of the coating layer CF in a normal line direction (e.g., the third direction DR3) of a main extension plane (e.g., a plane defined by the first and second directions DR1 and DR2) of the supporting bar SB.

The coating layer CF may entirely cover the surface of the supporting bar SB, however, it should not be limited thereto or thereby. In an embodiment, the coating layer CF may cover some areas of the surface of the supporting bar SB to overlap the grooves GR in which the glass plates GL are loaded. In an embodiment, the coating layer CF may cover the bottom surface BS and the inner side surfaces IN1 and IN2, which define the grooves GR.

The coating layer CF may be in contact with the glass plates GL loaded into the loading apparatus LD. In detail, the coating layer CF formed or provided to overlap the grooves GR may be in contact with the glass plates GL loaded in the grooves GR.

The coating layer CF may include a material having a heat resistance so as not to be deformed at a high temperature. In an embodiment, the coating layer CF may include a metal material, a carbon composite, or a ceramic that is not deformed at a temperature of about 400 degrees Celsius (° C.).

The coating layer CF may be in contact with the molten salt with high temperature in the strengthening process of the glass plate GL. The coating layer CF may include a material having an erosion resistance to prevent the surface thereof from being damaged by the high-temperature molten salt.

The coating layer CF may include a material having hydrophobicity (hereinafter, also referred to as a hydrophobic material). The coating layer CF including the hydrophobic material may have a relatively low affinity with the molten salt. The molten salt having the low affinity with the coating layer CF may not be easily dispersed on the surface of the coating layer CF, and the molten salts may aggregate with each other. A fluidity of the molten salt having the low affinity with the coating layer CF may increase on the coating layer CF. Accordingly, the molten salt on the coating layer CF may be condensed on a lower portion of the supporter SP1, which is not in contact with the glass plate GL, or may fall down due to the influence of gravity. Therefore, when the supporter SP1 is immersed in the molten salt and then taken out, an amount of the molten salt remaining on the supporter SP1 (hereinafter, also referred to as a residual salt) may be reduced by the coating layer CF.

The coating layer CF may include a material with the hydrophobicity and the heat resistance, e.g., Teflon (polytetrafluoroethylene/PTFE), molybdenum (Mo) compound (e.g., Molybdenum disulfide, MoS₂), ceramic, metal oxide, or a combination of two or more of them, however, it should not be limited thereto or thereby. The ceramic may include at least one of alumina, silica, magnesia, zirconia, and mullite. The metal oxide may include at least one of aluminum oxide, molybdenum oxide, manganese oxide, and magnesium oxide.

The coating layer CF may be formed or disposed on the supporting bar SB by a spraying, coating, plasma-depositing, sputtering depositing, or chemical vapor depositing method. After the coating layer CF is formed or disposed on the supporting bar SB, the supporting bar SB on which the coating layer CF is formed or provided may be coupled with the frames FR1 and FR2, however, it should not be limited thereto or thereby. In an embodiment, after the supporting bar SB is coupled with the frames FR1 and FR2, the coating layer CF may be formed or disposed on the supporting bar SB using the above-mentioned methods. Accordingly, the coating layer CF may be formed or provided not only on the supporting bar SB but also on components forming the loading apparatus LD, e.g., the frames FR1 and FR2 and/or the sub-supporter SP-s.

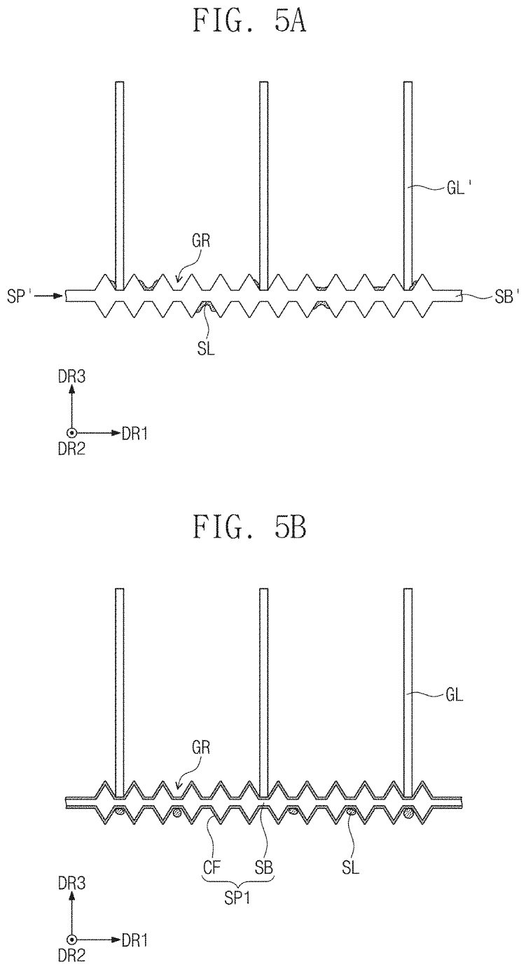

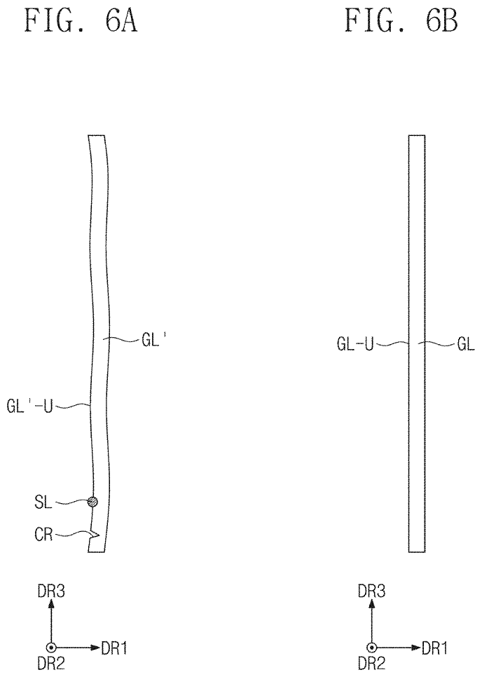

FIGS. 5A and 5B are cross-sectional views showing an embodiment of supporters according to the invention. FIG. 6A is a cross-sectional view showing a glass plate GL′ on which a strengthening process is performed after being loaded on a supporter SP′ shown in FIG. 5A, and FIG. 6B is a cross-sectional view showing a glass plate GL on which a strengthening process is performed after being loaded on a supporter SP1 shown in FIG. 5B.

FIG. 5A is a cross-sectional view schematically showing an embodiment of a state of the supporter SP′ that is provided with the glass plates GL′ loaded thereon, immersed into the molten salt, and then taken out of the molten salt. FIG. 5B is a cross-sectional view schematically showing an embodiment of a state of the supporter SP1 that is provided with the glass plates GL loaded thereon, immersed into the molten salt, and then taken out of the molten salt. The supporter SP1 shown in FIG. 5B may be substantially the same as the supporter SP1 shown in FIG. 4, and the above descriptions with reference to FIG. 4 may be applied to the supporter SP1 shown in FIG. 5B.

The supporter SP′ shown in FIG. 5A may include a supporting bar SB′. A material included in the supporting bar SB′ may have hydrophilicity greater than that of a material included in a coating layer CF shown in FIG. 5B.

The supporter SP1 shown in FIG. 5B may include a supporting bar SB and the coating layer CF coated on the supporting bar SB. A material included in the coating layer CF may have a relatively greater hydrophobicity than that of the material included in the supporting bar SB′ shown in FIG. 5A.

When the supporters SP′ and SP1 on which the glass plates GL′ and GL are respectively disposed are immersed in and taken out from the molten salt, a residual salt SL may remain on the supporters SP′ and SP1. The residual salt SL remaining on the supporter SP′ shown in FIG. 5A may be in contact with a surface of the supporting bar SB′. The residual salt SL remaining on the supporter SP1 shown in FIG. 5B may be in contact with a surface of the coating layer CF.

An affinity between the supporting bar SB′ including the material with the relatively great hydrophilicity when compared with the coating layer CF and the residual salt SL may be greater than an affinity between the coating layer CF including the hydrophobic material and the residual salt SL. Accordingly, the residual salt SL may be relatively well dispersed on the surface of the supporting bar SB′ and may be collected on the surface of the supporting bar SB′. An amount of the residual salt SL remaining in a groove GR of the supporting bar SB′ may be greater than an amount of the residual salt SL remaining on the coating layer CF overlapping the groove GR.

Since the affinity between the coating layer CF including the hydrophobic material and the residual salt SL is relatively small, the residual salt SL may not be spread well on the surface of the coating layer CF and may be agglomerated into the form of droplets. The residual salt SL with great fluidity on the coating layer CF may be condensed on a lower portion of the supporter SP1, which is not in contact with the glass plates GL, or may fall down due to the influence of gravity. Accordingly, the amount of the residual salt SL remaining on the coating layer CF of the supporter SP1 may be smaller than the amount of the residual salt SL remaining on the supporting bar SB′ of the supporter SP′.

The residual salt SL remaining on the supporting bar SB′ may be solidified on the groove GR and may be in contact with the glass plates GL′. Since a thermal expansion coefficient of the residual salt SL is different from a thermal expansion coefficient of the glass plates GL′, the glass plates GL′ may be subjected to an interfacial stress during the solidification of the residual salt SL. Accordingly, a quality in appearance of the glass plates GL′ may be deteriorated by the residual salt SL.

As a thickness of the glass plate GL decreases, the glass plate GL may be more vulnerable to the interfacial stress. Accordingly, as the thickness of the glass plate GL decreases, the glass plate GL may be more vulnerable to damages by the residual salt SL.

FIG. 6A is a cross-sectional view showing the glass plate GL′ whose appearance quality is deteriorated due to the residual salt SL. For the convenience of explanation, FIG. 6A exaggeratedly shows the deterioration of the appearance of the glass plate GL′, which may be caused by the residual salt SL, and the shape of the glass plate GL′ whose appearance quality is deteriorated should not be limited thereto or thereby.

As shown in FIG. 6A, the glass plate GL′ on which the strengthening process is performed while being loaded on the supporting bar SB′ with the residual salt SL remaining thereon may be bent or crumpled by the residual salt SL. In addition, the residual salt SL may be solidified on a surface GL′-U of the glass plate GL′ in an agglomerated state, and thus, a concave-convex portion may be formed or provided on the surface GL′-U of the glass plate GL′. In addition, the glass plate GL′ may be subjected to the stress by the solidified residual salt SL, and as a result, a crack CR may be generated in the glass plate GL′, and the glass plate GL′ may be pitted or broken.

FIG. 6B is a cross-sectional view showing the glass plate GL with the improved appearance quality. When the strengthening process is performed on the glass plate GL while the glass plate GL is loaded on the supporter SP1 with relatively less amount of residual salt SL due to the coating layer CF, the glass plate GL may be prevented from being damaged by the residual salt SL, and thus, the deterioration in appearance quality of the glass plate GL may be prevented. In an embodiment, the glass plate GL with the improved appearance quality may include a surface GL-U that is flat without damages by the residual salt SL.

Table 1 below shows results of evaluating the amount of residual salt in a comparative example and an embodiment example after the strengthening process of the glass plate. The comparative example corresponds to a structure in which the coating layer is removed from the supporter shown in FIG. 4. The embodiment example corresponds to the supporter shown in FIG. 4 and includes a supporting bar and a coating layer coated on the supporting bar. In the comparative example and the embodiment example, the supporting bar includes a stainless steel. In the embodiment example, the coating layer includes the ceramic.

The comparative example and the embodiment example were evaluated through the same operations including, pre-heating operation, strengthening operation, and post-heating operation. In the pre-heating operation of the evaluation, the supporter of the comparative example and the supporter of the embodiment example were heated at a temperature of about 370 degrees Celsius (° C.) for about 5 minutes. In the strengthening operation of the evaluation, the supporter of the comparative example and the supporter of the embodiment example were immersed in the molten salt, which is heated to about 370 degrees Celsius (° C.), for about 14 minutes. In the post-heating operation, the supporter of the comparative example and the supporter of the embodiment example were taken out from the molten salt and left at about 370 degrees Celsius (° C.) for about 10 minutes.

TABLE 1

| | Before | After | Weight of | Difference in |
|---|---|---|---|---|
| | evaluation | evaluation | residual | weight between |
| | (g) | (g) | salt (g) | residual salts |
| Comparative | 229.204 | 231.907 | 2.703 | 0.168 |
| example | | | | |
| Embodiment | 236.294 | 238.829 | 2.535 | |
| example | | | | |

Referring to Table 1, the weight of the residual salt remaining on the supporter of the embodiment example was smaller than the weight of the residual salt remaining on the supporter of the comparative example. The difference in weight of the residual salt between the embodiment example and the comparative example was about 0.168 gram (g) in the evaluation. Accordingly, it was observed that the amount of the salt remaining on the supporter of the embodiment example was reduced by the coating layer including the hydrophobic material through the evaluation. Accordingly, the glass plates may be prevented from being damaged due to the residual salt when the strengthening process is performed on the glass plates that are loaded on the supporter according to the invention, and the appearance quality may be improved.

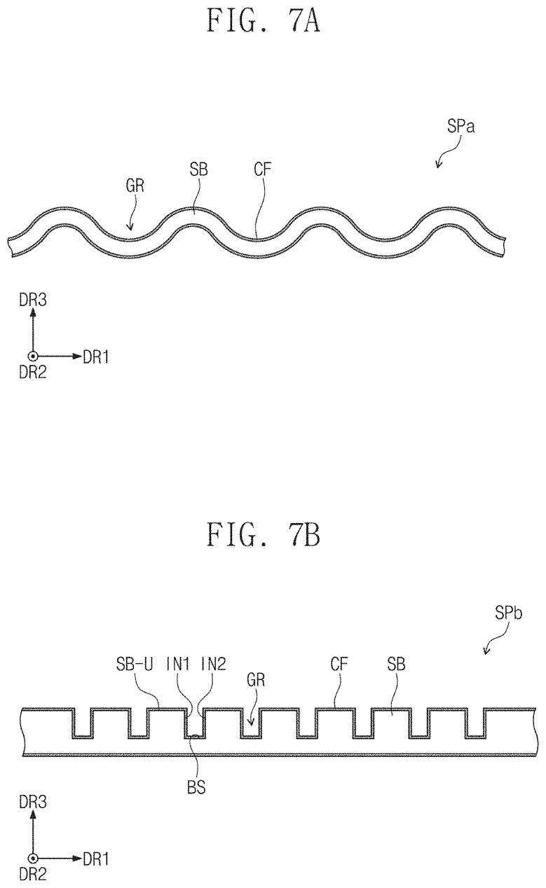

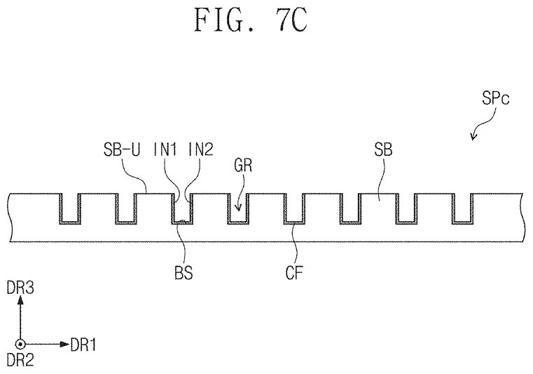

FIGS. 7A to 7C are cross-sectional views showing an embodiment of supporters SPa, SPb, and SPc according to the invention. The supporters SPa, SPb and SPc respectively shown in FIGS. 7A, 7B and 7C have different shapes from those of the supporter SP1 and include substantially the same elements as those of the supporter SP1 except some elements, and descriptions of the same elements are the same as the details described above.

The supporters SPa, SPb, and SPc may have a variety of shapes depending on a shape of a supporting bar SB. FIGS. 7A to 7C show some various types of supporting bars as a representative example, however, the shape of the supporting bar SB should not be particularly limited as long as grooves GR that support the side surfaces of the glass plates GL are defined in one direction.

Referring to FIG. 7A, the supporting bar SB may have a shape in which an upward convex shape and a downward convex shape are repeated in the first direction DR1. The grooves GR may be defined by curved surfaces each having the downward convex shape.

A coating layer CF may have a substantially uniform thickness and may cover a surface of the supporting bar SB to correspond to the shape of the supporting bar SB. The coating layer CF may cover an entire area of the supporting bar SB as shown in FIG. 7A, however, it should not be limited thereto or thereby. In an embodiment, the coating layer CF may cover some areas of the supporting bar SB overlapping the grooves GR.

Referring to FIGS. 7B and 7C, the supporting bar SB may be provided with a plurality of grooves GR defined therein by recessing a flat upper surface SB-U of the supporting bar SB. The grooves GR may be spaced apart from each other in the first direction DR1. In an embodiment, the grooves GR may be spaced apart from each other with a portion of the upper surface SB-U of the supporting bar SB interposed therebetween.

Each of the grooves GR may include inner side surfaces IN1 and IN2 and a bottom surface BS unitary with the inner side surfaces IN1 and IN2. The inner side surfaces IN1 and IN2 may be inclined with respect to the bottom surface BS, for example, may be surfaces substantially perpendicular to the bottom surface BS. The inner side surfaces IN1 and IN2 may be unitary with the upper surface SB-U of the supporting bar SB.

Referring to FIG. 7B, a coating layer CF may cover an entire area of the supporting bar SB. In detail, the coating layer CF may cover the entire area of the surface of the supporting bar SB, which includes an area overlapping the grooves GR in which the glass plates GL are loaded and an area overlapping the upper surface SB-U of the supporting bar SB, which is not in contact with the glass plates GL.

However, in an embodiment, the coating layer CF may cover at least some areas of the supporting bar SB. Referring to FIG. 7C, a coating layer CF may cover some areas of the supporting bar SB in which the glass plates GL are disposed and may be in contact with the glass plates GL. In an embodiment, the coating layer CF may cover areas of the supporting bar SB overlapping the grooves GR. The coating layer CF may cover the inner side surfaces IN1 and IN2 and the bottom surface BS, which define the grooves GR. The upper surface SB-U of the supporting bar SB, which does not overlap the grooves GR, may be exposed to the outside. The areas in which the coating layer CF is formed or provided should not be particularly limited as long as the areas in which the coating layer CF is formed or provided to overlap the areas in which the glass plates GL are loaded.

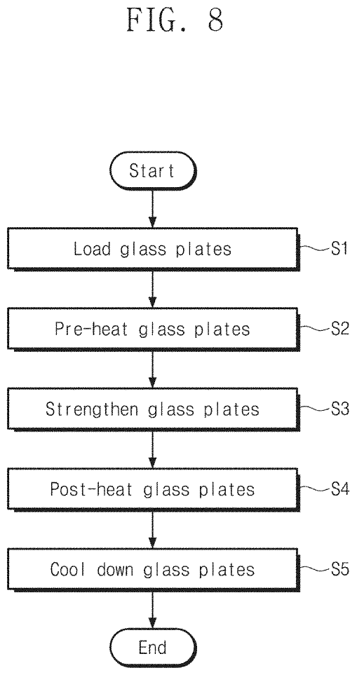

FIG. 8 is a flowchart showing an embodiment of a method of strengthening a glass plate according to the invention. The strengthening process may be performed on the glass plate while the glass plate is being loaded into the loading apparatus according to the invention. The strengthening method of the glass plate may include loading a plurality of glass plates into the loading apparatus (S1), pre-heating the glass plates at a first temperature (or referred to as a pre-heating operation) (S2), immersing the glass plates in a molten salt to strengthen the glass plates (S3), post-heating the glass plates at a second temperature (or referred to as a post-heating operation), after taking out the glass plates from the molten salt (S4), and placing the glass plates at room temperature (or referred to as a cooling down operation) (S5).

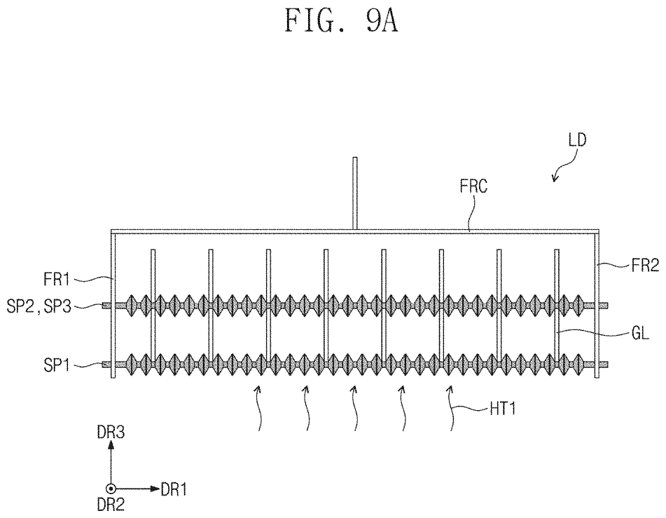

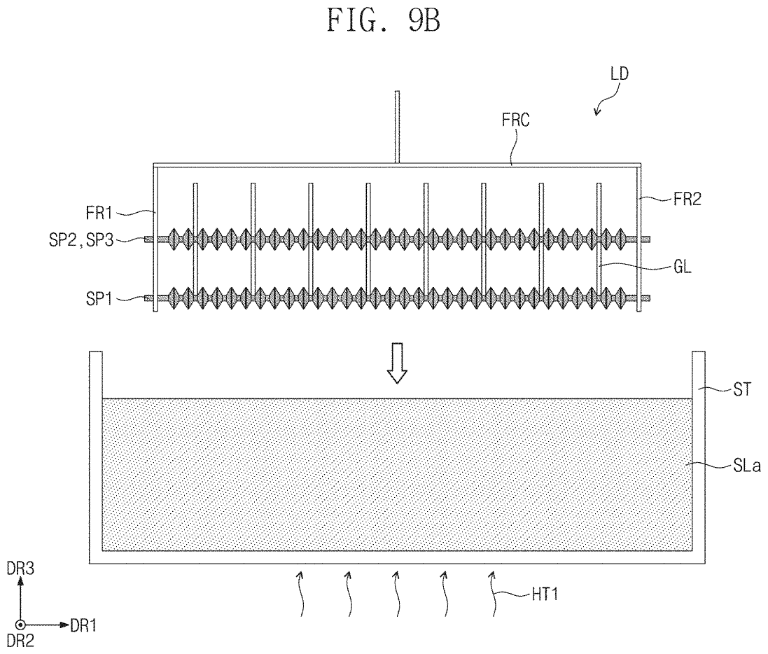

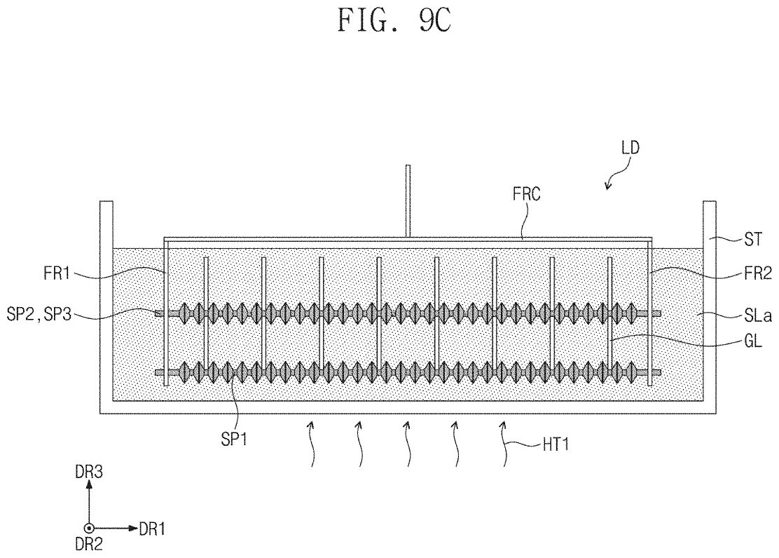

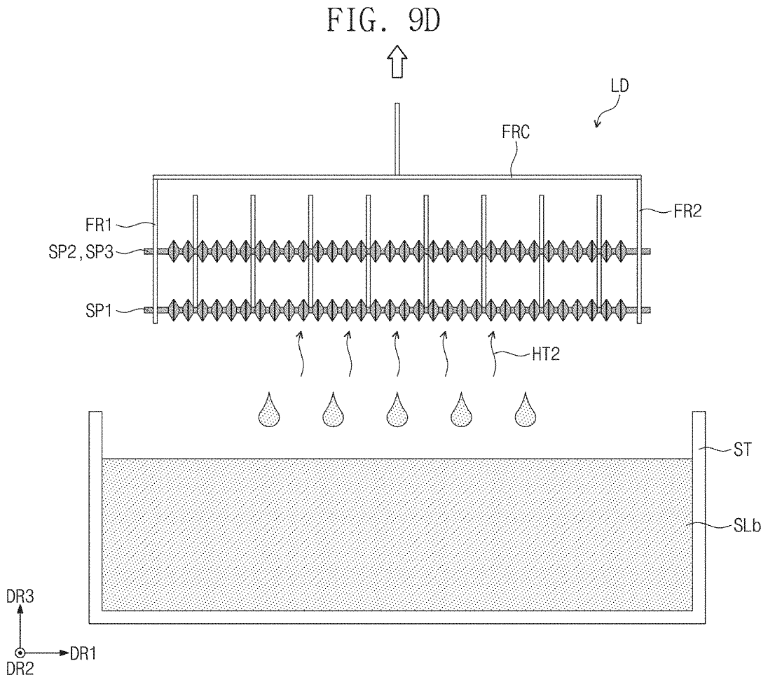

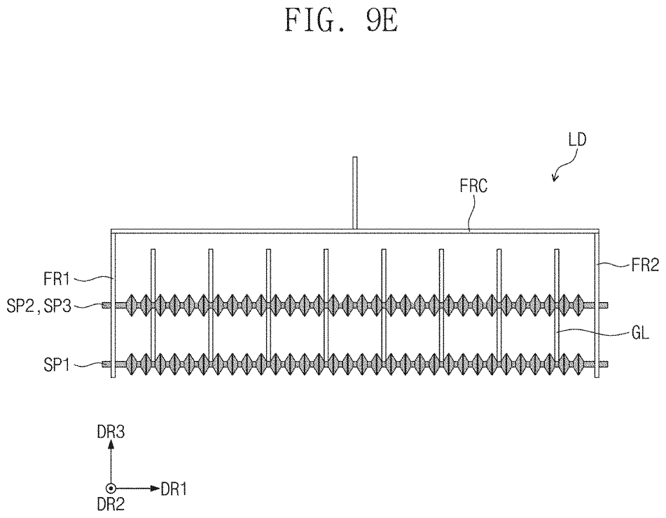

FIGS. 9A to 9E are cross-sectional views showing an embodiment of processes of strengthening the glass plate according to the invention. Descriptions of the loading apparatus LD shown in FIGS. 9A to 9E are the same as the details thereof described above, and the loading apparatus LD may further include other components in addition to the above-mentioned components.

The loading apparatus LD may further include a connection frame FRC connecting the first and second frames FR1 and FR2 to each other. The connection frame FRC may connect the first and second frames FR1 and FR2 to transfer the first and second frames FR1 and FR2 and the supporters SP1, SP2, and SP3 coupled with the first and second frames FR1 and FR2 at a time.

FIG. 9A shows the pre-heating operation of heating the glass plates GL at the first temperature HT1 after loading the glass plates GL into the loading apparatus LD. Since the glass plates GL and the loading apparatus LD may be damaged when the glass plates GL and the loading apparatus LD suddenly contact the hot molten salt SLa (refer to FIG. 9B), the glass plates GL and the loading apparatus LD may be gradually heated to the first temperature HT1 in the pre-heating operation to prevent the damage on the glass plates GL and the loading apparatus LD. The first temperature HT1 may be substantially the same as a temperature at which the salt is melted. In an embodiment, the first temperature HT1 may be equal to or greater than about 350 degrees Celsius (° C.) and equal to or less than about 400 degrees Celsius (° C.).

FIG. 9B shows the immersing of the loading apparatus LD into which the glass plates GL are loaded in the hot molten salt SLa (or referred to as the molten salt SLa). After the pre-heating operation, the glass plates GL may be immersed in the hot molten salt SLa to chemically strengthen the glass plates GL.

A bath ST may accommodate the molten salt SLa therein. The loading apparatus LD into which the glass plates GL are loaded may be provided above the bath ST in which the molten salt SLa is accommodated. The loading apparatus LD into which the glass plates GL are loaded may be transferred into the bath ST. The glass plates GL may be substantially simultaneously immersed in the molten salt SLa by the loading apparatus LD.

The bath ST in which the molten salt SLa is accommodated may maintain the first temperature HT1 to sufficiently melt the salt. The first temperature HT1 may be equal to or greater than about 350 degrees Celsius (° C.) and equal to or less than about 400 degrees Celsius (° C.).

In a case where the first temperature HT1 is less than about 350 degrees Celsius (° C.), the salt may not be sufficiently melted, and an ion exchange, which will be described later, may occur insufficiently. Due to this, the chemical strengthening of the glass plates GL may not be sufficient.

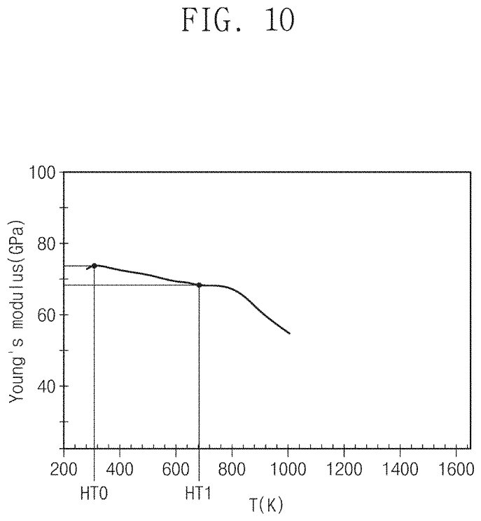

In a case where the first temperature HT1 is greater than about 400 degrees Celsius (° C.), the glass plates GL may be deformed. This will be described in detail with reference to FIG. 10.

FIG. 10 is a graph showing a Young's modulus of the glass plate GL as a function of a temperature. The Young's modulus of the glass plate GL may have a value within a range from about 65 gigapascals (GPa) to about 75 GPa at room temperature HT0. FIG. 10 shows the Young's modulus of the glass plate GL having a value of about 75 GPa at room temperature HT0 according to the temperature. Referring to FIG. 10, the Young's modulus of the glass plate GL may decrease as the temperature increases, and the Young's modulus of the glass plate GL may rapidly decrease when the temperature is equal to or greater than a glass transition temperature. Accordingly, the Young's modulus of the glass plate GL at the first temperature HT1 may be smaller than the Young's modulus of the glass plate GL at room temperature HT0.

As the Young's modulus of the glass plate GL decreases, a rigidity of the glass plate GL may decrease. As the rigidity of the glass plate GL decreases, an appearance of the glass plate GL may be easily deformed. Accordingly, when the first temperature HT1 is higher than about 400 degrees Celsius (° C.), the glass plate GL may be sagged or crumpled in the strengthening process. As a result, the appearance quality of the glass plate GL may be deteriorated.

FIG. 9C shows the immersing of the loading apparatus LD into which the glass plates GL are loaded in the molten salt SLa. The molten salt SLa may enter the space of the loading apparatus LD, which is exposed to the outside, and the molten salt SLa may be in contact with the surface of the glass plates GL.

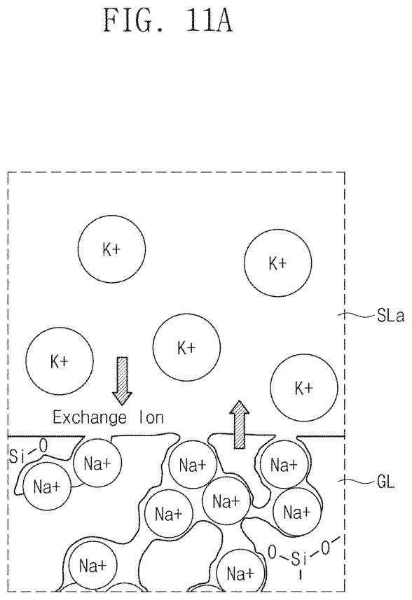

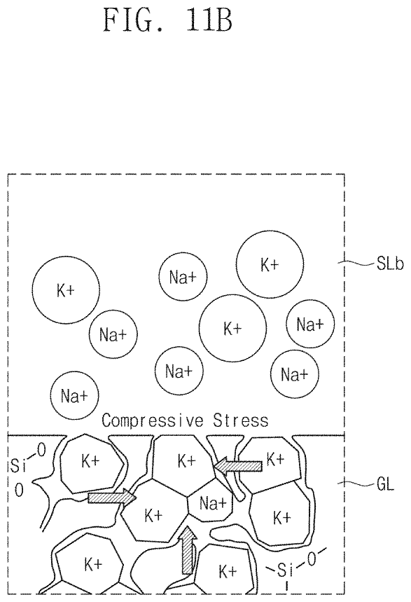

The ion exchange may occur in the surface of the glass plates GL, which is in contact with the molten salt SLa. The ion exchange will be described in detail with reference to FIGS. 11A and 11B. FIG. 11A schematically shows an ion exchange process of the glass plates GL immersed in the molten salt SLa. FIG. 11B schematically shows the molten salt SLb and the surface of the glass plate GL after the ion exchange.

Referring to FIGS. 11A and 11B, the molten salt SLa may include ions that are exchanged with ions included in the glass plate GL. In an embodiment, the molten salt SLa may include alkali metal ions, and in detail, the molten salt SLa may include lithium ion (Li+), sodium ion (Na+), potassium ion (K+), cesium ion (Cs+), or rubidium ion (Rb+). Each ion included in the molten salt SLa may have a diameter greater than each ion included in the glass plate GL. In an embodiment, the surface of the glass plate GL may include the sodium ion, and the molten salt SLa may include potassium ion.

Through the ion exchange, the ions included on the surface of the glass plate GL may be exchanged with the ions included in the molten salt SLa, which has a relatively large diameter. As shown in FIG. 11B, the sodium ion included in the glass plate GL may be exchanged with the potassium ion having a diameter larger than a diameter of the sodium ion. As the ions included in the surface of the glass plate GL are exchanged with the ions having the relatively large diameter, the surface of the glass plate GL may be subjected to a compressive stress. The glass plate GL may be strengthened by the compressive stress applied to the surface of the glass plate GL.

A degree of strengthening of the glass plate GL may be changed depending on a thickness of a portion in which the ions are exchanged. In an embodiment, insufficient or excessive exchange of ions may cause damages on the glass plate GL. Accordingly, the strengthening process of the glass plate GL is desired to perform the ion exchange for an appropriate time at an appropriate temperature.

FIG. 9D shows the post-heating of the glass plates GL after the loading apparatus LD into which the glass plates GL are loaded is taken out from the molten salt SLb. The loading apparatus LD into which the glass plates GL are loaded may be taken out from the bath ST in which the molten salt SLb is accommodated. The molten salt SLb remaining in the bath ST may be the molten salt SLb remained after the ion exchange with the glass plate GL.

Residual salts remaining on the loading apparatus LD into which the glass plates GL are loaded may be removed by dropping them down. As described above, the glass plates GL may be in contact with the coating layers of the supporters SP1, SP2, and SP3. The coating layers may include the hydrophobic material.

Due to the coating layer including the hydrophobic material, the affinity between the residual salt remaining on the coating layer and the coating layer may be relatively small. Due to this, the fluidity of the residual salt remaining on the coating layer may increase, and the residual salt may move to a lower portion of the supporters SP1, SP2, and SP3 or may be dropped down to be removed from the supporters SP1, SP2, and SP3 due to the gravity. Accordingly, the amount of the residual salt remaining on the supporters SP1, SP2, and SP3 may decrease, and the supporters SP1, SP2, and SP3 may prevent the glass plates GL from being damaged by the residual salt.

In the post-heating operation, the heat at the second temperature HT2 may be applied to the loading apparatus LD into which the glass plates GL are loaded. In an embodiment, the second temperature HT2 may be equal to or greater than about 220 degrees Celsius (° C.) and equal to or less than about 320 degrees Celsius (° C.).

In a case where the second temperature HT2 is greater than about 320 degrees Celsius (° C.), the residual salt remaining on the supporters SP1, SP2, and SP3 or the glass plates GL may infiltrate into the glass plate GL in the post-heating operation. As a result, a thickness of the residual salt infiltrated into the glass plate GL may increase, and the compressive stress may occur in the glass plate GL. The glass plate GL may be damaged by the compressive stress occurring in the glass plate GL.

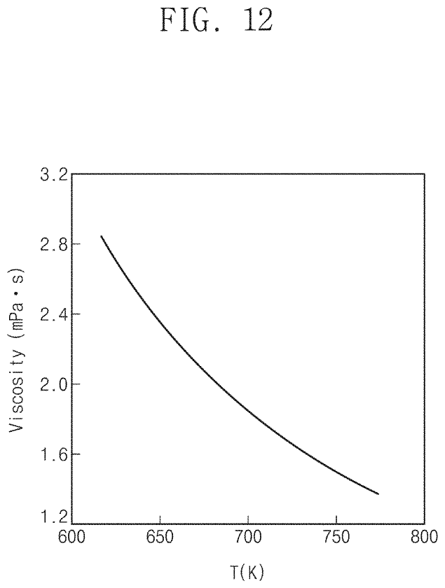

In a case where the second temperature HT2 is less than about 220 degrees Celsius (° C.), the amount of the residual salt remaining on the supporters SP1, SP2, and SP3 or the glass plates GL may increase. This will be described in detail with reference to FIG. 12.

FIG. 12 is a graph showing a viscosity of the molten salt as a function of a temperature, and in this case, the molten salt is the potassium nitrate (KNO₃) that is melted. Referring to FIG. 12, the viscosity of the molten salt may increase as the temperature decreases, and the fluidity of the molten salt may decrease as the viscosity of the molten salt increases. Accordingly, when the second temperature HT2 is less than about 220 degrees Celsius (° C.), the viscosity of the residual salt remaining on the supporters SP1, SP2, and SP3 or the glass plates GL may increase, and the fluidity of the residual salt may decrease. The amount of the residual salt remaining on the supporters SP1, SP2, and SP3 may increase due to the residual salt whose fluidity decreases. In particular, the amount of the residual salt remaining on the grooves GR (refer to FIG. 3) that support the glass plates GL may increase, and the glass plates GL may be damaged by the residual salt.

FIG. 9E shows the cooling down operation of placing the loading apparatus LD into which the glass plates GL are loaded at the room temperature. After post-heating operation of the glass plates GL, the glass plates GL may be placed at room temperature while being loaded into the loading apparatus LD, and the heat of the glass plates GL may be cooled down. Then, a cleaning operation and a drying operation may be further performed on the glass plates GL, and the strengthening process may be completed.

The loading apparatus according to the invention may load and transfer the glass plates and may be used in the strengthening process for the glass plates. The loading apparatus may include the supporter that supports the glass plates and includes the hydrophobic material. In the strengthening process, the loading apparatus into which the glass plates are loaded may be immersed in the molten salt, and thus, the residual salt may be provided on the supporter. Due to the supporter including the hydrophobic material, the fluidity of the residual salt on the supporter may increase, and the amount of the residual salt provided on the supporter may decrease. Accordingly, damages caused by the residual salt on the appearance of the glass plates may be prevented when the strengthening process is performed on the glass plates while the glass plates are loaded into the loading apparatus according to the invention.

Although the embodiments of the invention have been described, it is understood that the invention should not be limited to these embodiments but various changes and modifications may be made by one ordinary skilled in the art within the spirit and scope of the invention as hereinafter claimed.

Therefore, the disclosed subject matter should not be limited to any single embodiment described herein, and the scope of the invention shall be determined according to the attached claims.

What is claimed is:

1. A loading apparatus for glass plates, comprising:
a first frame;
a second frame facing the first frame; and
a plurality of supporters extending in a first direction, disposed between the first frame and the second frame, and coupled with the first frame and the second frame, each of the plurality of supporters comprising:
a supporting bar; and
a coating layer covering at least a portion of the supporting bar and comprising at least one of Teflon, molybdenum, ceramic, and metal oxide,
wherein the plurality of supporters supports the glass plates arranged in the first direction.

2. The loading apparatus of claim 1, wherein the ceramic comprises at least one of alumina, silica, magnesia, zirconia, and mullite.

3. The loading apparatus of claim 1, wherein the metal oxide comprises at least one of aluminum oxide, molybdenum oxide, manganese oxide, and magnesium oxide.

4. The loading apparatus of claim 1, wherein the glass plates are in contact with the coating layer.

5. The loading apparatus of claim 1, wherein the supporting bar is provided with a plurality of grooves defined therein along the first direction, and the plurality of grooves supports the glass plates.

6. The loading apparatus of claim 5, wherein each of the plurality of grooves comprises side surfaces and a surface disposed between the side surfaces,
the side surfaces face a first surface or a second surface of a corresponding glass plate among the glass plates, which is supported by a corresponding groove among the plurality of grooves, where the first surface of the corresponding glass faces the first frame and the second surface of the corresponding glass is opposite to the first surface and faces the second frame, and
the surface of each of the plurality of grooves faces a side surface of the corresponding glass plate among the glass plates, which is supported by the corresponding groove among the plurality of grooves.

7. The loading apparatus of claim 5, wherein each of the plurality of grooves is defined in a first surface of the supporting bar facing the glass plates, and
the plurality of grooves is spaced apart from each other with the first surface of the supporting bar interposed therebetween.

8. The loading apparatus of claim 5, wherein the coating layer covers an entire area of the supporting bar.

9. The loading apparatus of claim 5, wherein the coating layer covers some areas of the supporting bar overlapping the plurality of grooves.

10. The loading apparatus of claim 9, wherein the coating layer overlapping the plurality of grooves has a uniform thickness.

11. The loading apparatus of claim 1, wherein each of the glass plates comprises side surfaces, and the plurality of supporters comprises two or more supporters supporting different side surfaces among the side surfaces of each of the glass plates.

12. The loading apparatus of claim 1, wherein the first direction is substantially parallel to a normal line direction of a main extension plane of each of the glass plates.

13. The loading apparatus of claim 11, further comprising a sub-supporting bar coupled with the first frame and the second frame, wherein the sub-supporting bar is disposed on a side surface which is not supported by the plurality of supporters among the side surfaces of each of the glass plates.

14. The loading apparatus of claim 1, wherein each of the glass plates has a thickness equal to or greater than about 20 micrometers (μm) and equal to or less than about 50 micrometers (μm) in the first direction.

15. The loading apparatus of claim 1, wherein each of the glass plates has a Young's modulus equal to or greater than about 65 gigapascals (Gpa) and equal to or less than about 75 gigapascals (Gpa).

16. A method of strengthening glass plates, the method comprising:
loading the glass plates into a loading apparatus;
pre-heating the loading apparatus into which the glass plates are loaded at a first temperature;
immersing the loading apparatus into which the glass plates are loaded in a molten salt heated to the first temperature to strengthen the glass plates;
post-heating the loading apparatus into which the glass plates are loaded at a second temperature, after taking out the loading apparatus into which the glass plates are loaded from the molten salt; and
placing the glass plates under a room temperature to cool down the glass plates,
wherein the loading apparatus comprises a supporter to support the glass plates, and the supporter is coated with a coating layer comprising a hydrophobic material.

17. The method of claim 16, wherein the molten salt comprises a potassium ion.

18. The method of claim 16, wherein the first temperature is equal to or greater than about 350 degrees Celsius (° C.) and equal to or less than about 400 degrees Celsius (° C.).

19. The method of claim 16, wherein the second temperature is equal to or greater than about 220 degrees Celsius (° C.) and equal to or less than about 320 degrees Celsius (° C.).

20. The method of claim 16, wherein the coating layer comprises at least one of Teflon, molybdenum, ceramic, and metal oxide.
